(19) United States
(12) Patent Application Publication
(10) Pub. No.: US 2022/0390938 A1
(43) Pub. Date: Dec. 8, 2022

(54) STAGES OF COMPONENT CONTROLS FOR AUTONOMOUS VEHICLES

(71) Applicant: Waymo LLC, Mountain View, CA (US)

(72) Inventors: Guilherme Villar, San Francisco, CA (US); Clement Wright, San Francisco, CA (US); Maria Moon, Mountain View, CA (US); Bruce Mai, Sacramento, CA (US)

(21) Appl. No.: 17/340,875

(22) Filed: Jun. 7, 2021

(51) Int. Cl. G05D 1/00; B60W 60/00; H04W 4/02; H04W 4/40; G06Q 10/02; G06Q 50/30

(52) U.S. Cl. CPC G05D 1/0016; B60W 60/00253; B60W 60/0013; H04W 4/023; H04W 4/40; G06Q 10/02; G06Q 50/30; G05D 2201/0212

(57) ABSTRACT

A method for controlling an autonomous vehicle includes using one or more computing devices to transmit a request for a trip. The trip is from a pickup location to a destination location. The method also includes determining the autonomous vehicle for the trip is within a predetermined distance from the pickup location, providing a set of component controls to receive user input at a user interface after the determining. The set of component controls includes interactive controls for identifying or accessing the autonomous vehicle. A first user input is received at the user interface for one or more of the set of component controls, and control instructions for the autonomous vehicle based on the first user input are transmitted.

### BACKGROUND

Autonomous vehicles, such as vehicles that do not require a human driver, can be used to aid in the transport of passengers or items from one location to another. Such vehicles may operate in a fully autonomous mode where passengers may provide some initial input, such as a pickup or destination location, and the vehicle maneuvers itself to that location.

When a person (or user) wants to be physically transported between two locations via a vehicle, they may use any number of taxi services. To date, these services typically involve a human driver who is given dispatch instructions to a location to pick up the user. When the human driver nears the pickup location, they can begin to look for the user and make adjustments.

### BRIEF SUMMARY

Aspects of the disclosure provide for a method for controlling an autonomous vehicle. The method includes transmitting, by one or more computing devices, a request for a trip, the trip being from a pickup location to a destination location; determining, by the one or more computing devices, the autonomous vehicle for the trip is within a predetermined distance from the pickup location; after the determining, providing, by the one or more computing devices at a user interface, a set of component controls to receive user input, the set of component controls including interactive controls for identifying or accessing the autonomous vehicle; receiving, by the one or more computing devices, first user input at the user interface for one or more of the set of component controls; and transmitting, by the one or more computing devices, control instructions for the autonomous vehicle based on the first user input.

In one example, the set of component controls includes one or more input fields configured to receive user input related to automating actions of the autonomous vehicle. In another example, the method also includes providing, by the one or more computing devices at the user interface, a second set of component controls to receive user input prior to transmitting the request; receiving, by the one or more computing devices, second input at the user interface for the second set of component controls; and transmitting, by the one or more computing devices, second control instructions for the autonomous vehicle based on the second user input with the request. In this example, the method optionally also includes associating, by the one or more computing devices, the second input with a passenger profile. Also in this example, the second set of component controls optionally includes one or more input fields configured to receive user input related to external identifiers on the autonomous vehicle.

In a further example, the method also includes determining, by the one or more computing devices, that a passenger has boarded the autonomous vehicle; and after the determining that the passenger has boarded, causing, by the one or more computing devices, the interactive controls for identifying or accessing the vehicle to become unable to receive user input. In yet another example, the method also includes determining, by the one or more computing devices, that a passenger has boarded the autonomous vehicle; and after the determining that the passenger has boarded, providing, by the one or more computing devices at the user interface, a third set of component controls for controlling a cabin environment during the trip.

In a still further example, the method also includes determining, by the one or more computing devices, that the autonomous vehicle is within a second predetermined distance from the destination location; and after the determining that the autonomous vehicle is within the second predetermined distance from the destination location, providing, by the one or more computing devices at the user interface, a fourth set of component controls including one or more egress controls for accessing or exiting the autonomous vehicle. In this example, the method also includes causing, by the one or more computing devices, controls related to adjusting a cabin environment to become unable to receive user input. In another example, the method also includes establishing, by the one or more computing devices, a wireless connection with the autonomous vehicle; and transmitting the control instructions using the wireless connection.

Other aspects of the disclosure provide for a non-transitory, computer-readable medium configured to store instructions executable by one or more computing devices. The instructions, when executed, cause the one or more computing devices to perform a method for controlling an autonomous vehicle. The method includes transmitting a request for a trip, the trip being from a pickup location to a destination location; determining the autonomous vehicle for the trip is within a predetermined distance from the pickup location; after the determining, providing a set of component controls at a user interface to receive user input, the set of component controls including interactive controls for identifying or accessing the autonomous vehicle; receiving first user input at the user interface for one or more of the set of component controls; and transmitting control instructions for the autonomous vehicle based on the first user input.

In one example, the set of component controls includes one or more input fields configured to receive user input related to automating actions of the autonomous vehicle. In another example, the method also includes providing a second set of component controls at the user interface to receive user input prior to transmitting the request; receiving second input at the user interface for the second set of component controls; and transmitting second control instructions for the autonomous vehicle based on the second user input with the request. In this example, the method optionally also includes associating, by the one or more computing devices, the second input with a passenger profile. Also in this example, the second set of component controls optionally includes one or more input fields configured to receive user input related to external identifiers on the autonomous vehicle.

In a further example, the method also includes determining that a passenger has boarded the autonomous vehicle; and after the determining that the passenger has boarded, causing the interactive controls for identifying or accessing the vehicle to become unable to receive user input. In yet another example, the method also includes determining that a passenger has boarded the autonomous vehicle; and after the determining that the passenger has boarded, providing a third set of component controls for controlling a cabin environment during the trip at the user interface. In a still further example, the method also includes determining that the autonomous vehicle is within a second predetermined distance from the destination location; and after the determining that the autonomous vehicle is within the second predetermined distance from the destination location, providing a fourth set of component controls including one or more egress controls for accessing or exiting the autonomous vehicle at the user interface. In this example, the method optionally also includes causing controls related to adjusting a cabin environment to become unable to receive user input. In another example, the method also includes establishing a wireless connection with the autonomous vehicle; and wherein the transmitting the control instructions uses the wireless connection.

### BRIEF DESCRIPTION OF THE DRAWINGS

FIG. 1 is a functional diagram of an example vehicle in accordance with aspects of the disclosure.

FIG. 2 are example external views of a vehicle in accordance with aspects of the disclosure.

FIG. 3 is an example pictorial diagram of a system in accordance with aspects of the disclosure.

FIG. 4 is a functional diagram of the system of FIG. 3 in accordance with aspects of the disclosure.

FIG. 5 is an example pictorial diagram of messages sent through the system of FIG. 3 in accordance with aspects of the disclosure.

FIGS. 6A-6C are various example interfaces in accordance with aspects of the disclosure.

FIG. 7 is another example pictorial diagram of messages sent through the system of FIG. 4 in accordance with aspects of the disclosure.

FIG. 8 is an example flow diagram in accordance with aspects of the disclosure.

### DETAILED DESCRIPTION

### Overview

The technology relates to controlling parts of a vehicle while the vehicle is operating autonomously. The parts that may be controlled include doors, trunk, horn or other audio settings, lights, HVAC, or display settings. Default settings may be associated with a particular passenger profile or may otherwise be decoupled from a trip request. Settings may also be changed by a passenger at different points of a trip.

As the autonomous vehicle is traveling to the pickup location, a plurality of component controls may become available to the client device from which the trip request originated. Different controls may become available at different points along the trip, including, for example, before or with a trip request, after the trip request and vehicle assignment, when the vehicle is at or near the pickup location, after the passenger boards the vehicle, and when the vehicle is at or near the destination location. Based on user input related to the plurality of component controls, the autonomous vehicle may control its components to identify or provide access to the vehicle before the trip, to adjust to passenger preferences during the trip, and to allow safe deboarding at the end of the trip.

The technology herein may allow for a smoother trip in an autonomous vehicle for a passenger. For example, the cabin environment may be set for a particular passenger before reaching a pickup location. A passenger may also be able to identify the autonomous vehicle more easily as the autonomous vehicle responds to the user input. Furthermore, the technology allows for a more secure trip since the passenger can unlock doors in their own timing to enter the vehicle.

### Example Systems

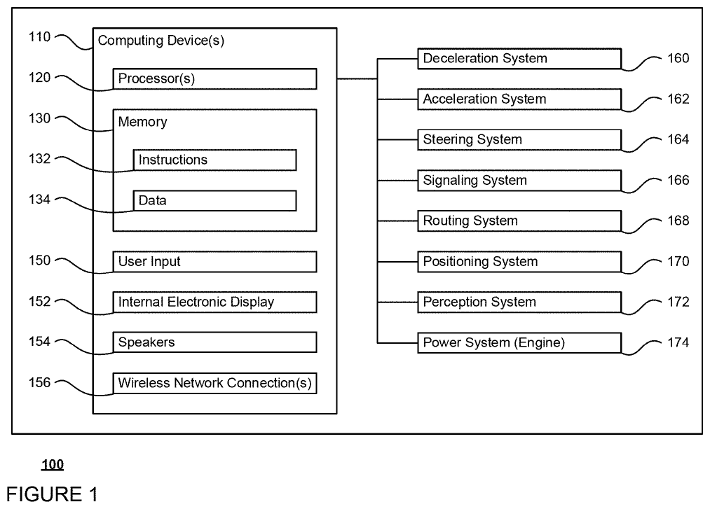

As shown in FIG. 1, a vehicle 100 in accordance with one aspect of the disclosure includes various components. While certain aspects of the disclosure are particularly useful in connection with specific types of vehicles, the vehicle may be any type of vehicle including, but not limited to, cars, trucks, motorcycles, busses, recreational vehicles, etc. The vehicle may have one or more computing devices, such as computing device 110 containing one or more processors 120, memory 130 and other components typically present in general purpose computing devices.

The memory 130 stores information accessible by the one or more processors 120, including instructions 132 and data 134 that may be executed or otherwise used by the processor 120. The memory 130 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. As an example, data 134 of memory 130 may store predefined scenarios. A given scenario may identify a set of scenario requirements including a type of object, a range of locations of the object relative to the vehicle, as well as other factors such as whether the autonomous vehicle is able to maneuver around the object, whether the object is using a turn signal, the condition of a traffic light relevant to the current location of the object, whether the object is approaching a stop sign, etc. The requirements may include discrete values, such as “right turn signal is on” or “in a right turn only lane”, or ranges of values such as “having an heading that is oriented at an angle that is 30 to 60 degrees offset from a current path of vehicle 100.” In some examples, the predetermined scenarios may include similar information for multiple objects.

The one or more processor 120 may be any conventional processors, such as commercially available CPUs. Alternatively, the one or more processors may be a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. As an example, internal electronic display 152 may be controlled by a dedicated computing device having its own processor or central processing unit (CPU), memory, etc. which may interface with the computing device 110 via a high-bandwidth or other network connection. In some examples, this computing device may be a user interface computing device which can communicate with a user's client device. Similarly, the memory may be a hard drive or other storage media located in a housing different from that of computing device 110. Accordingly, references to a processor or computing device will be understood to include references to a collection of processors or computing devices or memories that may or may not operate in parallel.

Computing device 110 may all of the components normally used in connection with a computing device such as the processor and memory described above as well as a user input 150 (e.g., a mouse, keyboard, touch screen and/or microphone) and various electronic displays (e.g., a monitor having a screen or any other electrical device that is operable to display information). In this example, the vehicle includes an internal electronic display 152 as well as one or more speakers 154 to provide information or audio visual experiences. In this regard, internal electronic display 152 may be located within a cabin of vehicle 100 and may be used by computing device 110 to provide information to passengers within the vehicle 100. In addition to internal speakers, the one or more speakers 154 may include external speakers that are arranged at various locations on the vehicle in order to provide audible notifications to objects external to the vehicle 100. The vehicle also may include one or more communication systems 156 configured to communicate wirelessly over a network to remote computing devices. For example, a communication system may be configured to connect with a central dispatching server system or one or more client devices.

In one example, computing device 110 may be an autonomous driving computing system incorporated into vehicle 100. The autonomous driving computing system may capable of communicating with various components of the vehicle. For example, returning to FIG. 1, computing device 110 may be in communication with various self-driving systems of vehicle 100, such as deceleration system 160 (for controlling braking of the vehicle), acceleration system 162 (for controlling acceleration of the vehicle), steering system 164 (for controlling the orientation of the wheels and direction of the vehicle), signaling system 166 (for controlling turn signals), navigation system 168 (for navigating the vehicle to a location or around objects), positioning system 170 (for determining the position of the vehicle), perception system 172 (for detecting objects in the vehicle's environment), and power system 174 (for example, a battery and/or gas or diesel powered engine) in order to control the movement, speed, etc. of vehicle 100 in accordance with the instructions 132 of memory 130 in an autonomous driving mode which does not require or need continuous or periodic input from a passenger of the vehicle. Again, although these systems are shown as external to computing device 110, in actuality, these systems may also be incorporated into computing device 110, again as an autonomous driving computing system for controlling vehicle 100.

The computing device 110 may control the direction and speed of the vehicle by controlling various components. By way of example, computing device 110 may navigate the vehicle to a destination location completely autonomously using data from the map information and navigation system 168. Computer 110 may use the positioning system 170 to determine the vehicle's location and perception system 172 to detect and respond to objects when needed to reach the location safely. In order to do so, computer 110 may cause the vehicle to accelerate (e.g., by increasing fuel or other energy provided to the engine by acceleration system 162), decelerate (e.g., by decreasing the fuel supplied to the engine, changing gears, and/or by applying brakes by deceleration system 160), change direction (e.g., by turning the front or rear wheels of vehicle 100 by steering system 164), and signal such changes (e.g., by lighting turn signals of signaling system 166). Thus, the deceleration system 160 and acceleration system 162 may be a part of a drivetrain that includes various components between an engine of the vehicle and the wheels of the vehicle. Again, by controlling these systems, computer 110 may also control the drivetrain of the vehicle in order to maneuver the vehicle autonomously.

As an example, computing device 110 may interact with deceleration system 160 and acceleration system 162 in order to control the speed of the vehicle. Similarly, steering system 164 may be used by computing device 110 in order to control the direction of vehicle 100. For example, for vehicle 100 that is configured for use on a road, such as a car or truck, the steering system may include components to control the angle of wheels to turn the vehicle. Signaling system 166 may be used by computing device 110 in order to signal the vehicle's intent to other drivers or vehicles, for example, by lighting turn signals or brake lights when needed.

Navigation system 168 may be used by computing device 110 in order to determine and follow a route to a location. In this regard, the navigation system 168 and/or data 134 may store map information, e.g., highly detailed maps that computing devices 110 can use to navigate or control the vehicle. As an example, these maps may identify the shape and elevation of roadways, lane markers, intersections, crosswalks, speed limits, traffic signal lights, buildings, signs, real time traffic information, vegetation, or other such objects and information. The lane markers may include features such as solid or broken double or single lane lines, solid or broken lane lines, reflectors, etc. A given lane may be associated with left and right lane lines or other lane markers that define the boundary of the lane. Thus, most lanes may be bounded by a left edge of one lane line and a right edge of another lane line.

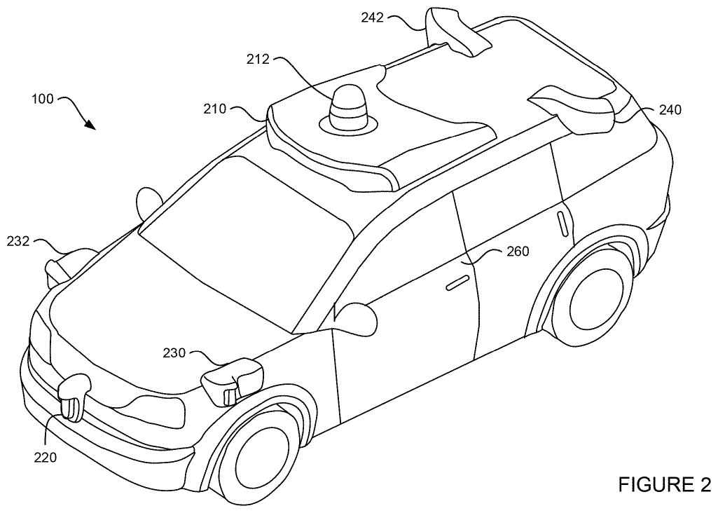

FIG. 2 is an example external view of vehicle 100 including aspects of the perception system 172. For instance, roof-top housing 210 and dome housing 212 may include a LIDAR sensor or system as well as various cameras and radar units. In addition, housing 220 located at the front end of vehicle 100 and housings 230, 232 on the driver's and passenger's sides of the vehicle may each store a LIDAR sensor or system. For example, housing 230 is located in front of driver door 260. Vehicle 100 also includes housings 240, 242 for radar units and/or cameras also located on the roof of vehicle 100. Additional radar units and cameras (not shown) may be located at the front and rear ends of vehicle 100 and/or on other positions along the roof or roof-top housing 210.

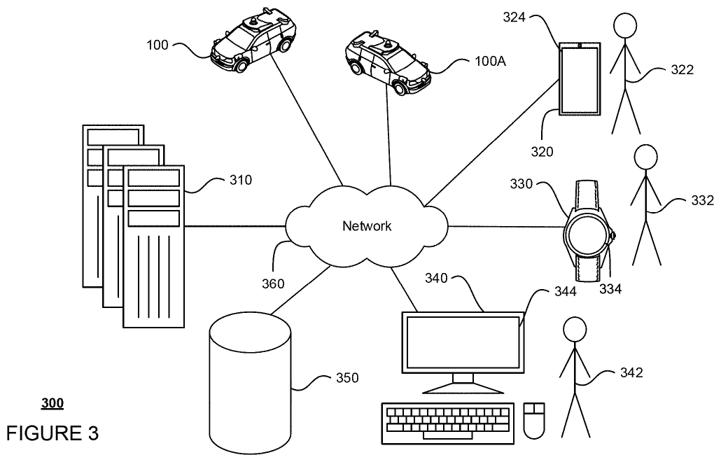

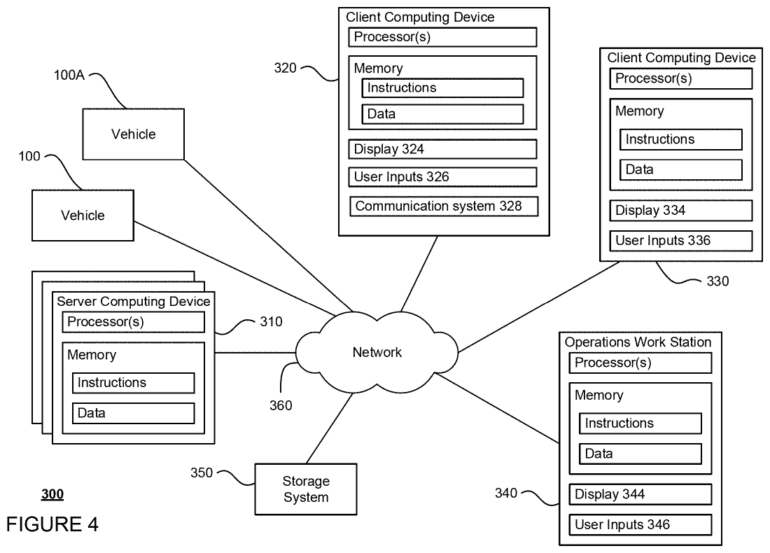

The one or more computing devices 110 of vehicle 100 may also receive or transfer information to and from other computing devices. FIGS. 3 and 4 are pictorial and functional diagrams, respectively, of an example system 300 that includes a plurality of computing devices 310, 320, 330, 340 and a storage system 350 connected via a network 360. System 300 also includes vehicle 100, and vehicle 100A which may be configured similarly to vehicle 100. Although only a few vehicles and computing devices are depicted for simplicity, a typical system may include significantly more.

As shown in FIG. 3, each of computing devices 310, 320, 330, 340 may include one or more processors, memory, data and instructions. Such processors, memories, data and instructions may be configured similarly to one or more processors 120, memory 130, instructions 132, and data 134 of computing device 110.

The network 360, and intervening nodes, may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, one or more computing devices 310 may include a server having a plurality of computing devices, e.g., a load balanced server farm, that exchange information with different nodes of a network for the purpose of receiving, processing and transmitting the data to and from other computing devices. For instance, one or more computing devices 310 may include one or more server computing devices that are capable of communicating with one or more computing devices 110 of vehicle 100 or a similar computing device of vehicle 100A as well as client computing devices 320, 330, 340 via the network 360. The one or more server computing devices may be a central dispatching system. For example, vehicles 100 and 100A may be a part of a fleet of vehicles that can be dispatched by server computing devices to various locations. In this regard, the vehicles of the fleet may periodically send the server computing devices location information provided by the vehicle's respective positioning systems and the one or more server computing devices may track the locations of the vehicles.

In addition, server computing devices 310 may use network 360 to transmit and present information to a user, such as user 322, 332, 342 on a display, such as displays/interfaces 324, 334, 344 of computing devices 320, 330, 340. In this regard, computing devices 320, 330, 340 may be considered client computing devices.

As shown in FIG. 4, each client computing device 320, 330, 340 may be a personal computing device intended for use by a user 322, 332, 342, and have all of the components normally used in connection with a personal computing device including a one or more processors (e.g., a central processing unit (CPU)), memory (e.g., RAM and internal hard drives) storing data and instructions, a display such as displays/interfaces 324, 334, 344 (e.g., a monitor having a screen, a touch-screen, a projector, a television, or other device that is operable to display information), and user input devices 326, 336, 346 (e.g., a mouse, keyboard, touch-screen or microphone). Some of the client computing devices, such as client computing device 320, may also include a communication system 328 configured to communicate wirelessly over a network to remote computing devices. The communication may send a trip request for a trip in an autonomous vehicle. The trip request may be sent to the autonomous vehicle through the network to cause the autonomous vehicle to travel to a pickup location and then to a destination location.

Although the client computing devices 320, 330, and 340 may each comprise a full-sized personal computing device, they may alternatively comprise mobile computing devices capable of wirelessly exchanging data with a server over a network such as the Internet. By way of example only, client computing device 320 may be a mobile phone or a device such as a wireless-enabled PDA, a tablet PC, a wearable computing device or system, or a netbook that is capable of obtaining information via the Internet or other networks. In another example, client computing device 330 may be a wearable computing system, shown as a head-mounted computing system in FIG. 4. As an example, the user may input information using a small keyboard, a keypad, microphone, using visual signals with a camera, or a touch screen.

In some examples, client computing device 340 may be a concierge work station used by an administrator to provide concierge services to users such as users 322 and 332. For example, a concierge 342 may use the concierge work station 340 to communicate via a telephone call or audio connection with users through their respective client computing devices or vehicles 100 or 100A in order to ensure the safe operation of vehicles 100 and 100A and the safety of the users as described in further detail below. Although only a single concierge work station 340 is shown in FIGS. 3 and 4, any number of such work stations may be included in a typical system.

Storage system 350 may store various types of information as described in more detail below. This information may be retrieved or otherwise accessed by a server computing device, such as one or more server computing devices 310, in order to perform some or all of the features described herein. For example, the information may include user account information such as credentials (e.g., a user name and password as in the case of a traditional single-factor authentication as well as other types of credentials typically used in multi-factor authentications such as random identifiers, biometrics, etc.) that can be used to identify a user to the one or more server computing devices. The user account information may also include personal information such as the user's name, contact information, identifying information of the user's client computing device (or devices if multiple devices are used with the same user account), as well as one or more unique signals for the user.

The storage system 350 may also store routing data for generating and evaluating routes between locations. For example, the routing information may be used to estimate how long it would take a vehicle at a first location to reach a second location. In this regard, the routing information may include map information, not necessarily as particular as the detailed map information described above, but including roads, as well as information about those roads such as direction (one way, two way, etc.), orientation (North, South, etc.), speed limits, as well as traffic information identifying expected traffic conditions, etc.

The storage system 350 may also store information which can be provided to client computing devices for display to a user. For instance, the storage system 350 may store predetermined distance information for determining an area at which a vehicle is likely to stop for a given pickup or destination location. The storage system 350 may also store graphics, icons, and other items which may be displayed to a user as discussed below.

As with memory 130, storage system 350 can be of any type of computerized storage capable of storing information accessible by the server computing devices 310, such as a hard-drive, memory card, ROM, RAM, DVD, CD-ROM, write-capable, and read-only memories. In addition, storage system 350 may include a distributed storage system where data is stored on a plurality of different storage devices which may be physically located at the same or different geographic locations. Storage system 350 may be connected to the computing devices via the network 360 as shown in FIG. 3 and/or may be directly connected to or incorporated into any of the computing devices 110, 310, 320, 330, 340, etc.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

In one aspect, a user may download an application for requesting a vehicle to a client computing device. For example, users 322 and 332 may download the application via a link in an email, directly from a website, or an application store to client computing devices 320 and 330. In another example, client computing device 320 or 330 may transmit a request for the application over the network, such as to one or more server computing devices 310, and in response, receive the application. The application may be installed locally at the client computing device 320 or 330.

The user may then use a client computing device to access the application and send a trip request to be a passenger in an autonomous vehicle. As an example, a user such as user 322 may use client computing device 320 to send a request to one or more server computing devices 310 for a vehicle. As part of this, the user may identify a pickup location, a destination location, and, in some cases, one or more intermediate stopping locations anywhere within a service area where a vehicle can stop.

These pickup and destination locations may be predefined (e.g., specific areas of a parking lot, etc.) or may simply be any location within a service area of the vehicles. As an example, a pickup location can be a current location of the user's client computing device 320, or can be input by the user at the user's client computing device 320. For instance, the user may enter an address or other location information or select a location on a map to select a pickup location. Selecting the location may include a user using a finger to tap on a map displayed on the display 324 of client computing device 320. In response, the location of the tap on the map, displayed as a map marker, may be identified as a requested location. In other examples, the user may select a location from a series of saved locations, a list of recent locations, or a set of locations corresponding to a search query such as from a map or location-based search engine.

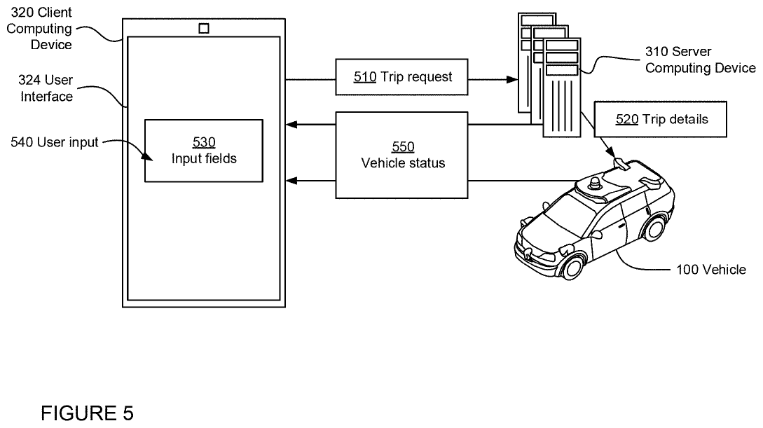

As shown in FIG. 5, the server computing device 310 may receive a trip request 510 from a client computing device, such as client computing device 320, select an autonomous vehicle 100 to perform a trip that fulfills the trip request, and send trip details 520 for the trip to the one or more computing devices 110 of the autonomous vehicle 100. The trip request 510 may include trip details 520 for the trip such as a current passenger location, a pickup location, or a destination location. Alternatively, the trip request 510 and the trip details 520 may be transmitted directly from the client computing device 320 to the vehicle's computing devices 110.

The vehicle's computing devices 110 may receive the trip details 520 for a trip based on the trip request 510 initiated by client computing device 320. Using the trip details 520, the vehicle's computing devices 110 may navigate the autonomous vehicle 100 to a pickup location to perform a trip as requested. The pickup location may be in the trip details 520 or may be determined based on a current passenger location.

As the autonomous vehicle 100 is traveling to a pickup location for a trip, one or more processors of the client computing device from which the trip request 510 originated may provide one or more input fields for a plurality of component controls at its user interface. The plurality of component controls may differ for a different vehicle, corresponding to the components of the different vehicle. As shown in FIG. 5, input fields 530 related to vehicle 100 may be displayed on display/interface 324 of client computing device 320 when the vehicle 100 is selected for trip request 510 originated by the client computing device 320. Different input fields may become available at different points along the trip, including, for example, before or with a trip request, after the trip request and vehicle assignment, when the vehicle is at or near the pickup location, after the passenger boards the vehicle, and when the vehicle is at or near the destination location.

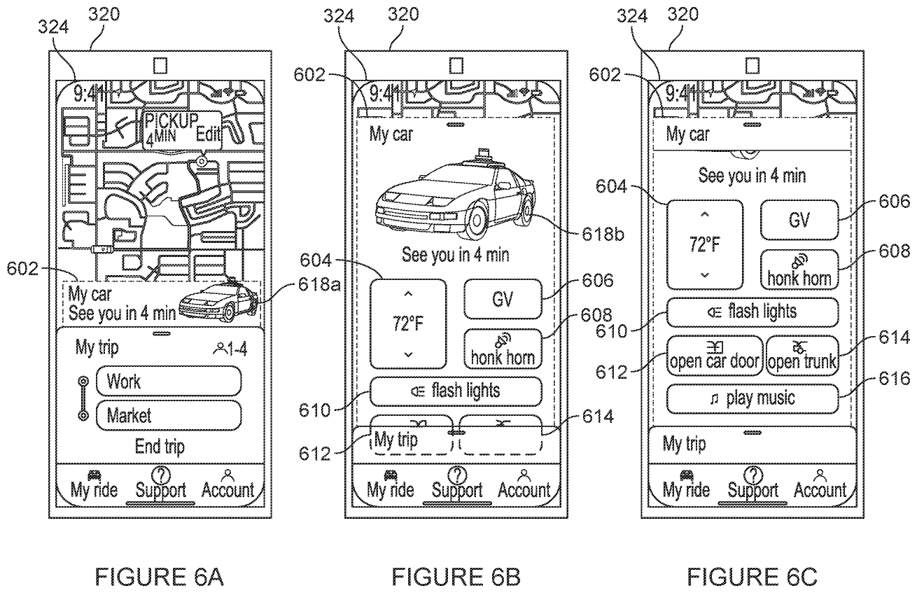

At any point in time, including prior to or concurrently with a trip request, preferences for a particular passenger profile may be set based on user input, such as user input 540. One or more first input fields may be available at the client device for receiving the user input for these preferences. As shown in FIG. 6A, the user interface 324 for the application may include a tab 602 for vehicle component controls separate from the trip details for the trip. As shown in FIG. 6B, under the tab 602, a plurality of input fields 604, 606, 608, 610 may be displayed in the user interface 324. Additional input fields may be partially hidden (such as input fields 612, 614) or completely hidden (such as input field 616), and may be displayed when the display is scrolled or otherwise moved, as shown in FIG. 6C. In this example, the input fields include a temperature control 604, an external display control 606, a horn control 608, headlight control 610, door control 612, trunk control 614, and audio control 616, among others. The temperature control 604 and the external display control 614 may be the first input fields that are available at any point in time including prior to or concurrently with a trip request, while the other controls are not available until a later point in time as discussed in further detail below. The unavailable controls may not be displayed or may be shown but unable to receive user input. The temperature control 604 may be configured to receive user input for a cabin temperature for an autonomous vehicle assigned to the trip request, and the external display control 606 may be configured to receive user input for an identifier for the assigned autonomous vehicle, including identifying letters, colors, fonts, etc. to appear on a display on the assigned autonomous vehicle (when available).

Other first input fields that may be made available on the user interface prior to or concurrently with the trip request for receiving user input include, but are not limited to, the following component controls:
Sound control for playing sound or music from external car speakers or other vehicle sound generator, the sound control being configured to receive user input related to type or content of audio greeting, whether sound or music is played when a user presses a control via the client computing device, automatically when a vehicle is at a pickup location, or automatically when a passenger is detected within a range of an autonomous vehicle;
Other heating, ventilation, and air conditioning (HVAC) control for controlling an HVAC system of an autonomous vehicle, the HVAC control being configured to receive user input related to fan speed, air temperature, or air flush;
Door control for unlocking and/or opening one or more doors of a vehicle, the door control being configured to receive user input related to which door(s) to open for passenger loading and whether a door opens when a user presses a control via the client computing device, automatically when a vehicle is at a pickup location, or automatically when a passenger is detected within a range of an autonomous vehicle;
Music control for playing music in the cabin of an autonomous vehicle, the music control being configured to receive user input related to a music selection, whether to auto-play a music selection, volume level;
Audio cues control for adjusting audio cues played by an autonomous vehicle that describe input (entered into a client device or vehicle interfaces), controls (such as any of the controls described herein), actions (such as turns, estimated time of arrival, etc.), or other events for a passenger to hear, usually during a trip, the audio cues control being configured to receive user input related to turning audio cues on or off or verbosity (i.e., frequency or level of detail for the audio cues);
Exterior lighting control for controlling any exterior lighting of a vehicle, such as a puddle light, the exterior lighting controls being configured to receive user input related to turning exterior lighting on or off, an identifier that is projected using the exterior lighting, or color of the exterior lighting;
Seating control for controlling seats in a vehicle, the seating control being configured to receive user input related to positioning of a seat at a location in the vehicle in traditional or non-traditional setups, recline of a seat, or seat warmer/cooler settings; and
Child lock control for turning child lock for the doors on or off.

In the absence of user input, default settings may be used as set preferences. The default settings may include, for example, a default temperature for the cabin temperature and default letters, colors, and font for the identifier. The set preferences may be stored in association with the particular passenger profile and communicated from the client device to any autonomous vehicle that is assigned to a trip for a trip request associated with the particular passenger profile via the server computing device 310. In some implementations, the set preferences may be stored at the server computing device 310 or a storage system 350 accessible by the server computing device 310.

Once an autonomous vehicle 100 is assigned to the passenger for the trip, instructions may be transmitted to the vehicle's computing devices 110 including the set preferences. The instructions may be transmitted from the server computing devices 310 based on stored set preferences. The vehicle's computing devices 110 may perform actions to implement the set preferences. Performing the actions may include determining one or more steps for the actions and a timing for the one or more steps to achieve the set preferences by the time the autonomous vehicle reaches a pickup location. For example, the set preference for cabin temperature may be 72 degrees Fahrenheit, and the vehicle computing devices 110 may determine a step of turning on a fan at a highest setting and a timing of approximately 5 minutes before reaching the pickup location based on a current temperature in the cabin.

In addition, a current state of the assigned autonomous vehicle to the trip may be provided to the client computing device that originated the trip request. As shown in FIG. 5, the current state may be transmitted from the autonomous vehicle 100 to the server computing devices 310, which then transmits the current state to the client computing device 320 as part of the vehicle status 550. Alternatively, the current state may be transmitted from the autonomous vehicle 100 to the client computing device 320 as part of the vehicle status 550. The current state may include one or more steps currently implemented at the autonomous vehicle 100 to conform to the preferences associated with the passenger profile. The one or more first input fields for receiving input for the first set of component controls may remain available at the client computing device 320 for additional user input. Additional instructions may be transmitted to the vehicle's computing devices 110 for implementing any updated preferences indicated by the additional user input. For example, the temperature may be adjusted to 70 degrees Fahrenheit instead of the originally set 72 degrees Fahrenheit. The vehicle's computing devices 110 may receive the updated temperature and determine one or more steps to adjust to the updated temperature.

The current state of the assigned autonomous vehicle may include details about make, model, and other physical characteristics of the vehicle. After receiving the details, the client computing device 320 may provide a visual representation of the assigned autonomous vehicle showing the physical characteristics of the vehicle. As shown in FIGS. 6A and 6B, the one or more processors of the client computing device may provide an image 618a, 618b in the tab 602 for the vehicle component controls.

When the autonomous vehicle 100 is within a first predetermined distance from the pickup location of the trip, the vehicle's computing devices 110 may perform actions from the set preferences associated with being at or near the pickup location. For example, the component settings that are set to automatically happen at or near the pickup location may include displaying an identifier on the external display, playing an audio greeting, displaying exterior lighting, or unlocking/opening a door. In some implementations, there may be additional stages based on different distances at or near the pickup location or based on different distances from a client device location. For certain component controls, there may be additional conditions in addition to the location of the vehicle, such as time of day, outdoor brightness, or vehicle velocity. For instance, the vehicle being stationary may be a condition for unlocking or opening a door of the vehicle.

In addition, the one or more processors of the client computing device 320 may receive location updates 550 of the autonomous vehicle 100, as shown in FIG. 5. The location updates 550 may be received from the autonomous vehicle 100 or from the server computing devices 310 to which the autonomous vehicle 100 transmits location updates. A first location update may include when the autonomous vehicle is within a first predetermined distance from the pickup location. In other implementations, the first location update may include an indication that the autonomous vehicle is in range of a wireless connection with the client device. The wireless connection may be, for example, an IEEE 802.11 connection or a Bluetooth connection. Alternatively, the first location update may be an instruction to make controls available that is transmitted when the vehicle's computing devices or the server computing devices determine that the autonomous vehicle is within the first predetermined distance from the pickup location.

In response to the location updates 550, the one or more processors of the client computing device 320 may provide one or more second input fields for receiving user input related to a second set of component controls. The second set of component controls at this stage may include interactive controls for identifying and/or accessing the autonomous vehicle. These interactive controls may not be available prior to the autonomous vehicle being at or near the pickup location due to safety, security, or other reasons. For example, the second set of component controls may include controls for door actions (lock/unlock, open/close), window actions (open/close), external sounds (honk horn, other signal sound), external lights (flash headlights, emergency lights), or camera actions (show view from vehicle location, capture selfie), in addition to the first set of component controls. In the example shown in FIGS. 6B-6C, the horn control 608, headlight control 610, door control 612, and trunk control 614 may be the second input fields that are made available after the client computing device 320 receives the first location update. The first input fields 604, 606 may still be available along with the second input fields 608, 610, 612, 614, while other input fields are unavailable.

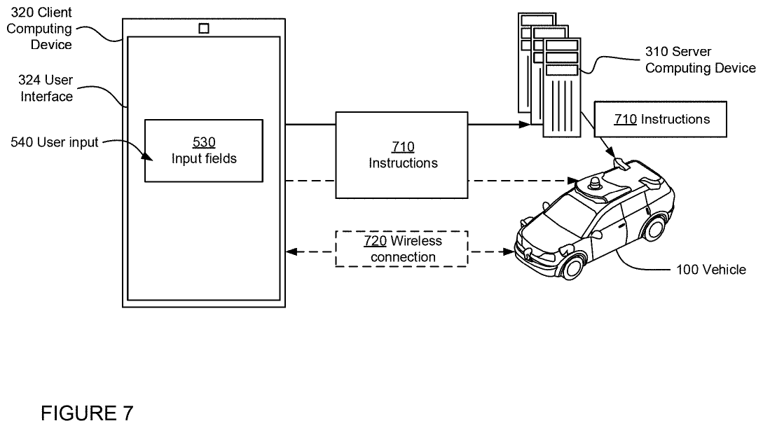

The client computing device 320 may receive user input at the one or more second fields via the user interface 324 for controlling one or more components of the autonomous vehicle 100, such as user input 540 at input fields 530. For example, the user input may be to press the horn control 608 to honk the horn, press the headlight control 610 to flash the headlights, press the door control 612 to unlock or open a door, or press the trunk control 614 to unlock or open the trunk. The client computing device 320 may transmit instructions 710 for the autonomous vehicle 100 based on the user input. As shown in FIG. 7, the instructions 710 may be transmitted to the server computing devices 310, which may transmit the instructions 710 to the autonomous vehicle 100. Based on the transmitted instructions, the vehicle's computing devices 110 may perform actions corresponding to the user input. The occurrence of the corresponding action may allow the passenger to identify or access the autonomous vehicle. Alternatively, when the autonomous vehicle 100 is within range of a wireless connection 720 with the client computing device 320, the wireless connection 720 may be formed between the autonomous vehicle 100 and the client computing device 320 may directly transmit the instructions 710 wirelessly to the autonomous vehicle 100 in response to the user input, as shown in FIG. 7. In some implementations, the application may also provide an animation of the autonomous vehicle 100 performing an action similar to the action of the autonomous vehicle corresponding to the user input. For example, as shown in FIG. 6B, the one or more processors of the client computing device may animate the image 618b in the tab 602 to simulate the action corresponding to the user input, such as showing headlights flashing when the headlight control 610 is pressed.

The one or more processors of the client computing device 320 may determine that the passenger has boarded the autonomous vehicle 100. The determination may be based on the client computing device 320 detecting its location is in the autonomous vehicle 100, user input received at the client device, or an indication received from the autonomous vehicle 100 that the passenger has boarded and the doors are closed.

After it is determined that the passenger has boarded, one or more controls may become unavailable, such as, for example, the component controls for identifying or accessing the autonomous vehicle. In the example shown in FIGS. 6B and 6C, the external display control 606, a horn control 608, headlight control 610, door control 612, and trunk control 614 may become unavailable at this stage. Other controls may remain available for the passenger at the client computing device, such as, for example, the component controls for adjusting the cabin environment. In the example shown in FIGS. 6B and 6C, the temperature control 604 may remain available. Still other controls may become available for the passenger at the client computing device as one or more third user input fields related to starting a trip, controlling the cabin environment during the trip, making an intermediate stop, or ending a trip. For example, in FIG. 6C, the music control 616 may become available at this stage for the passenger to start playing music while in the autonomous vehicle 100.

The client computing device 320 may determine that the autonomous vehicle 100 or client computing device is within a second predetermined distance from the destination location. The determination may be based on the client computing device 320 detecting its current location, an indication received from the autonomous vehicle 100 regarding the location of the autonomous vehicle 100, or user input received at the client computing device 320.

After it is determined that the autonomous vehicle 100 or the client computing device 320 is within the second predetermined distance from the destination location, one or more egress controls for accessing/exiting the autonomous vehicle may become available, such as, for example, controls for door actions (open/close). Other controls may become unavailable, such as, for example, the component controls for adjusting the cabin environment, starting a trip, making an intermediate stop, or ending a trip. Controls for identifying the autonomous vehicle may remain unavailable. In the example shown in FIGS. 6B and 6C, the door control 612 and the trunk control 614 may become available. The music control 616 may become unavailable, and the external display control 606, a horn control 608, and headlight control 610 may remain unavailable.

In some alternative implementations, the client computing device 320 that provides the trip request may not be associated with the passenger for the trip. The client computing device may designate another client computing device or passenger profile to receive access to the component controls for the autonomous vehicle 100 sent for the trip. The other client computing device 310 may then receive the user input and connect with the autonomous vehicle 100 as described above.

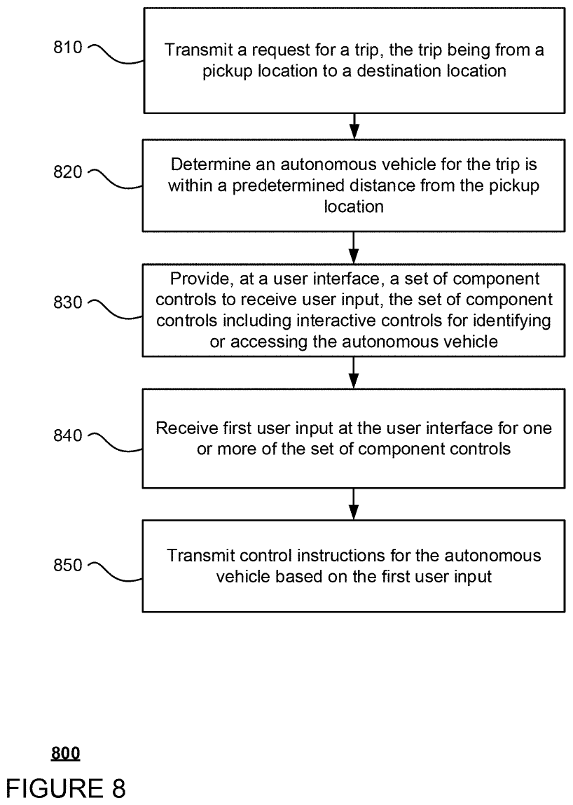

FIG. 8 shows an example flow diagram 800 in accordance with aspects of the disclosure. More specifically, FIG. 8 shows a flow of an example method for controlling an autonomous vehicle performed by one or more processors of a client computing device 320, 330. Alternatively, one or more of the steps in the example method may be performed by one or more computing devices remote from the client computing device 320, 330, such as server computing devices 310.

At block 810, one or more processors may transmit a request for a trip. The trip is from a pickup location to a destination location. At block 820, the one or more processors may determine that an autonomous vehicle for the trip is within a first distance from the pickup location. At block 830, the one or more processors may provide a set of component controls to receive user input at a user interface, such as in one or more input fields. The set of component controls may include interactive controls for identifying or accessing the autonomous vehicle. At block 840, the one or more processors may receive first user input at the user interface for one or more of the set of component controls. At block 850, the one or more processors may transmit control instructions to the autonomous vehicle based on the first user input.

The technology herein may allow for a smoother trip in an autonomous vehicle for a passenger. For example, the cabin environment may be set for a particular passenger before reaching a pickup location. A passenger may also be able to identify the autonomous vehicle more easily as the autonomous vehicle responds to the user input. Furthermore, the technology allows for a more secure trip since the passenger can unlock doors in their own timing to enter the vehicle.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for controlling an autonomous vehicle comprising:
transmitting, by one or more computing devices, a request for a trip, the trip being from a pickup location to a destination location;
determining, by the one or more computing devices, the autonomous vehicle for the trip is within a predetermined distance from the pickup location;
after the determining, providing, by the one or more computing devices at a user interface, a set of component controls to receive user input, the set of component controls including interactive controls for identifying or accessing the autonomous vehicle;
receiving, by the one or more computing devices, first user input at the user interface for one or more of the set of component controls; and
transmitting, by the one or more computing devices, control instructions for the autonomous vehicle based on the first user input.

2. The method of claim 1, wherein the set of component controls includes one or more input fields configured to receive user input related to automating actions of the autonomous vehicle.

3. The method of claim 1, further comprising:
providing, by the one or more computing devices at the user interface, a second set of component controls to receive user input prior to transmitting the request;
receiving, by the one or more computing devices, second input at the user interface for the second set of component controls; and
transmitting, by the one or more computing devices, second control instructions for the autonomous vehicle based on the second user input with the request.

4. The method of claim 3, further comprising associating, by the one or more computing devices, the second input with a passenger profile.

5. The method of claim 3, wherein the second set of component controls includes one or more input fields configured to receive user input related to external identifiers on the autonomous vehicle.

6. The method of claim 1, further comprising:
determining, by the one or more computing devices, that a passenger has boarded the autonomous vehicle; and
after the determining that the passenger has boarded, causing, by the one or more computing devices, the interactive controls for identifying or accessing the vehicle to become unable to receive user input.

7. The method of claim 1, further comprising:
determining, by the one or more computing devices, that a passenger has boarded the autonomous vehicle; and
after the determining that the passenger has boarded, providing, by the one or more computing devices at the user interface, a third set of component controls for controlling a cabin environment during the trip.

8. The method of claim 1, further comprising:
determining, by the one or more computing devices, that the autonomous vehicle is within a second predetermined distance from the destination location; and
after the determining that the autonomous vehicle is within the second predetermined distance from the destination location, providing, by the one or more computing devices at the user interface, a fourth set of component controls including one or more egress controls for accessing or exiting the autonomous vehicle.

9. The method of claim 8, further comprising causing, by the one or more computing devices, controls related to adjusting a cabin environment to become unable to receive user input.

10. The method of claim 1, further comprising:
establishing, by the one or more computing devices, a wireless connection with the autonomous vehicle; and
transmitting the control instructions using the wireless connection.

11. A non-transitory, computer-readable medium configured to store instructions executable by one or more computing devices, the instructions, when executed, cause the one or more computing devices to perform a method for controlling an autonomous vehicle, the method comprising:
transmitting a request for a trip, the trip being from a pickup location to a destination location;
determining the autonomous vehicle for the trip is within a predetermined distance from the pickup location;
after the determining, providing a set of component controls at a user interface to receive user input, the set of component controls including interactive controls for identifying or accessing the autonomous vehicle;
receiving first user input at the user interface for one or more of the set of component controls; and
transmitting control instructions for the autonomous vehicle based on the first user input.

12. The medium of claim 11, wherein the set of component controls includes one or more input fields configured to receive user input related to automating actions of the autonomous vehicle.

13. The medium of claim 11, wherein the method further comprises:
providing a second set of component controls at the user interface to receive user input prior to transmitting the request;
receiving second input at the user interface for the second set of component controls; and
transmitting second control instructions for the autonomous vehicle based on the second user input with the request.

14. The medium of claim 13, wherein the method further comprises associating, by the one or more computing devices, the second input with a passenger profile.

15. The medium of claim 13, wherein the second set of component controls includes one or more input fields configured to receive user input related to external identifiers on the autonomous vehicle.

16. The medium of claim 11, wherein the method further comprises:
determining that a passenger has boarded the autonomous vehicle; and
after the determining that the passenger has boarded, causing the interactive controls for identifying or accessing the vehicle to become unable to receive user input.

17. The medium of claim 11, wherein the method further comprises:
determining that a passenger has boarded the autonomous vehicle; and
after the determining that the passenger has boarded, providing a third set of component controls for controlling a cabin environment during the trip at the user interface.

18. The medium of claim 11, wherein the method further comprises:
determining that the autonomous vehicle is within a second predetermined distance from the destination location; and
after the determining that the autonomous vehicle is within the second predetermined distance from the destination location, providing a fourth set of component controls including one or more egress controls for accessing or exiting the autonomous vehicle at the user interface.

19. The medium of claim 18, wherein the method further comprises causing controls related to adjusting a cabin environment to become unable to receive user input.

20. The medium of claim 11, wherein the method further comprises:
establishing a wireless connection with the autonomous vehicle; and wherein
the transmitting the control instructions uses the wireless connection.
